(19) United States
(12) Patent Application Publication
(10) Pub. No.: US 2004/0024751 A1
(43) Pub. Date: Feb. 5, 2004

(54) User-prioritized search system

(76) Inventors: Greg C. Petrisor, Los Angeles, CA (US); Scot A. Reader, Sherman Oaks, CA (US)

Correspondence Address: Scot A. Reader, Esq., 3424 Woodcliff Road, Sherman Oaks, CA, 91403, US

(21) Appl. No.: 10/212,396

(22) Filed: Aug. 5, 2002

(51) Int. Cl. G06F 7/00

(52) U.S. Cl. 707/3

(57) ABSTRACT

A user-prioritized search system. A user inputs keywords and keyword priorities. The keyword priorities are based on the user's assessment of the relative importance of the keywords to the search. The keyword and keyword priorities are applied to produce prioritized queries which are in turn applied in a querying session to produce prioritized search results. The querying session terminates when conformity of the prioritized search results with a target result parameter is confirmed. The user may input the target result parameter as well.

### RELATED APPLICATION DATA

This application is related to U.S. application Ser. No. 10/163,048 entitled “SEARCH SYSTEM” filed Jun. 5, 2002.

### BACKGROUND OF THE INVENTION

The Internet hosts billions of Web pages. Millions more are added every day. The workhorse for finding information in this vast public library is the Internet search engine. An Internet search engines generally requires a user to manually determine keywords and manually input the keywords into a Web browser. The keywords are translated into a search query in a syntax supported is by the search engine and sent to a search engine query server. The query server resolves the query to search response including search results and the search results are returned and displayed in the Web browser.

A significant problem with conventional Internet search engines is manual query repetition. When user-provided keywords are too broad, the search response includes a large number of search results having low average relevance. This often creates a “needle in the haystack” problem wherein to find sought-after information the user would have to sift through hundreds of irrelevant search results and visit dozens of irrelevant Web pages. Result ranking algorithms may improve the chances that relevant search results appear early in the search response; however, result ranking algorithms by themselves are suboptimal since they rank search results based on abstract criteria, such as Web page popularity, that neglect the user's personal search goals. Conversely, when user-provided keywords are too narrow, the search response includes few or even zero search results. This often creates a different problem wherein the information the user is seeking is not even accessible from the search results.

Faced with either problem, the user often elects to repeat the search by manually re-determining and re-inputting new keywords. This “trial and error” approach to Internet searching, extrapolated across hundreds of millions of searches, causes endless frustration and a significant drain on human capital.

### SUMMARY OF THE INVENTION

In a basic feature, the present Invention provides a search method and system which eliminates most manual query repetition through user-prioritized searching. Instead of following the convention of a single search based on keywords provided by a user, user-prioritized searching supports a querying session in which a series of prioritized searches are performed based on keywords and associated keyword priorities provided by a user until conformity with a target result parameter which may also be provided by the user is confirmed. That is, if the highest priority search as determined from user-provided keywords and associated keyword priorities does not return search results in conformity with the target result parameter (e.g. too few search results), user-prioritized searching automatically performs the next highest priority search as determined from the user-provided keywords and associated keyword priorities, and so on, until search results in conformity with the target result parameter (e.g. target number of search results) are ultimately returned.

In one aspect, therefore, the present invention provides a method for prioritized searching comprising: accepting pairs of keywords and keyword priorities; applying the pairs to produce prioritized search queries; and applying the prioritized search queries to produce prioritized search results.

In another aspect, the present invention provides a method for prioritized searching comprising: accepting pairs of keywords and keyword priorities; applying the pairs to produce prioritized search queries; applying the prioritized search queries to produce prioritized search results; and checking for conformity between the prioritized search results and a target result parameter.

In another aspect, the present invention provides a prioritized search system comprising: a search client; a search agent; and a search server, wherein the search client transmits pairs of keywords and keyword priorities to the search agent, and the search agent applies the pairs to produce prioritized search queries and transmits the prioritized search queries to the search server to produce prioritized search results.

In yet another aspect, the present invention provides a prioritized search system comprising: a search client; a search agent; and a search server, wherein the search client transmits pairs of keywords and keyword priorities to the search agent, and the search agent: applies the pairs to produce prioritized search queries, applies the prioritized search queries with the search server to produce prioritized search results and checks for conformity between the prioritized search results and a target result parameter.

These and other aspects of the present invention will be better understood by reference to the following detailed description, taken in conjunction with the accompanying drawings briefly described below. Of course, the actual scope of the Invention is defined by the appended claims.

### BRIEF DESCRPTION OF THE DRAWINGS

FIG. 1 is a schematic of a network architecture in accordance with a first preferred embodiment;

FIG. 2 is a functional diagram of a search agent operative in the network architecture according to FIG. 1;

FIG. 3 is a flow diagram of a method for user-prioritized searching in the network architecture according to FIG. 1; and

FIG. 4 is a schematic of a network architecture in accordance with a second preferred embodiment.

### DETAILED DESCRIPTION OF THE PREFERRED EMBODIMENT

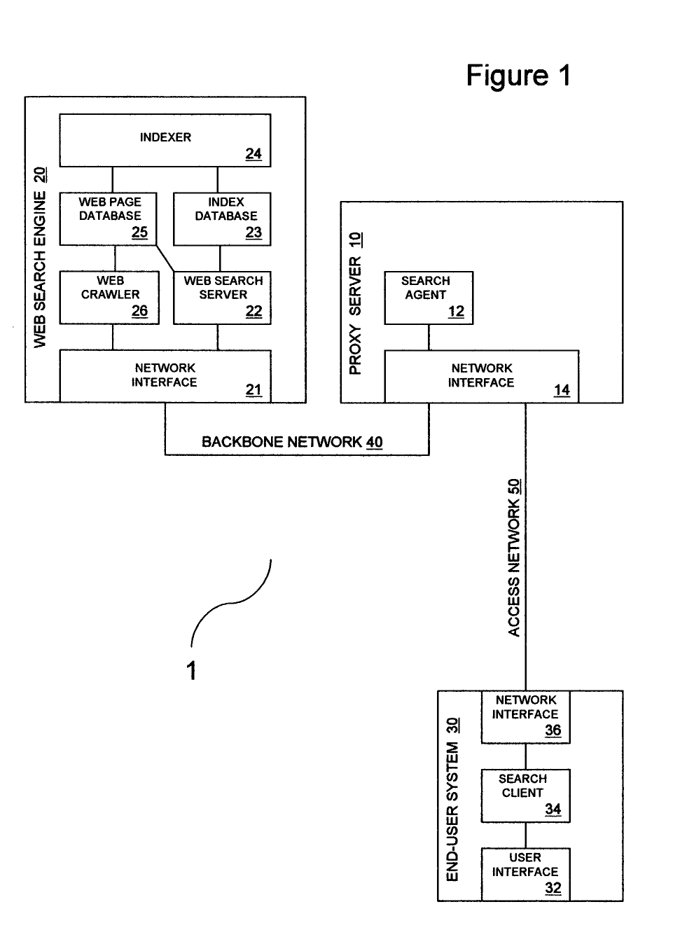

Referring to FIG. 1, a network architecture 1 in accordance with a first preferred embodiment is shown. Architecture 1 includes a proxy server 10, a Web search engine 20 and an end-user system 30. Proxy server 10 and Web search engine 20 are interconnected over a backbone network 40. Proxy server and end-user system 30 are interconnected over an access network 50. Physical layer connectivity between proxy server 10, Web search server 20 and end-user system 30 may be wired or wireless or some combination thereof and may be include an arbitrary number of intermediate hops which are not shown. Data link and network layer connectivity between proxy server 10, Web search server 20 and end-user system 30 may utilize one or more local area network (LAN) and wide area network data (WAN) communication protocols such as Ethernet, Token Ring, Fiber Distributed Data Interface (FDDI), Asynchronous Transfer Mode (ATM), Frame Relay, Multiprotocol Label Switching (MPLS), Internet Protocol (IP) and Internet Packet Exchange (IPX). Proxy server 10, Web search server 20 and end-user system 30 locate one another using well-known IP addresses or Domain Name Services (DNS). End-user system 30 may be a desktop computer, notebook computer, cell phone, personal data assistant, workstation or other Web-enabled end-system. Although architecture 1 is illustrated to include three interconnected nodes, namely, proxy server 10, Web search engine 20 and end-user system 30, it will be appreciated that each of these three nodes may be interconnected to an arbitrary number of other nodes which are not shown.

End-user system 30 includes a user interface 32, a search client 34 and a network interface 36. User interface 32 is a display for viewing textual and graphical information including search results. Search client 34 is a microprocessor-driven software application, such as a general purpose Web browser, for facilitating information exchange between end-user system 30 and other nodes and for facilitating information viewing on user interface 32. Facilitation of information exchange includes accepting search requests, generating search queries from search requests, transmitting search queries and receiving search responses. Accepting search requests includes accepting search pairs, such as pairs of keywords and keyword priorities, and target result parameters, such as target search result counts, from a user on user interface 32. Generating search queries includes generating from search pairs and target result parameters accepted on user interface 32 Uniform Resource Identifiers (URIs), as defined in, for example, Internet Engineering Task Force (IETF) Request for Comment (RFC) 2616, and encapsulating URIs in Hypertext Transfer Protocol (HTTP) GET requests, as defined in, for example, IETF RFC 2396. A keyword is preferably one or more words to be treated as a unitary search element in search query resolution and search result resolution. Keyword priorities are preferably numerical values associated with keywords reflecting relative priorities to be assigned to keywords in resolving search queries. Transmitting search queries includes transmitting HTTP GET requests. Receiving search responses includes accepting result information from network interface 36. Facilitation of information viewing includes facilitating display of result information on user interface 32. Network interface 36 is an application specific integrated circuit (ASIC)-based physical, data link and network layer device for transmitting, receiving and formatting information exchanged between end-user system 30 and other nodes.

Web search engine 20 includes a network interface 21, a Web search server 22, an index database 23, an indexer 24, a Web page database 25 and a Web crawler 26. Network interface 21 is an ASIC-based physical, data link and network layer device for transmitting, receiving and formatting information exchanged between Web search engine 20 and querying nodes. Web search server 22 is a single microprocessor-driven software application or an array of load-balanced microprocessor-driven software applications for resolving search queries to search results. Resolving a search query to search results includes extracting a URI including a search string from an HTTP GET request received from a querying node, performing a “look up” operation in index database 23 to identify Web pages matching the search string, retrieving the Web pages from Web page database 25, ranking the Web pages in accordance with abstract criteria, such as the proximity of different keywords within the Web page or the popularity of the Web page, formatting the Web pages into a search response in a Hypertext Markup Language (HTML) or Extensible Markup Language (XML) format and returning the search response to the querying node. Matching of a search string and a Web page may be defined in relation to an independent match of each keyword in the search string with the Web page. When a keyword includes one word, a match of the keyword may be defined in relation to inclusion in the Web page of the one word. When a keyword includes multiple words, it can be presented in either an “exact phrase” syntax whereby a match of the keyword may be defined in relation to inclusion in the Web page of the phrase, or a logical “OR” syntax whereby a match of the keyword may be defined in relation to inclusion in the Web page of any of the multiple words. Index database 23 includes one or more data stores having word-to-Web page associations. Web crawler 26 is a microprocessor-based software application that visits Web servers hosting websites, extracts Web pages therefrom and stores the Web pages in Web page database 25. Indexer 24 adds to index database 23 word-to-Web page associations for Web pages stored in Web page database 25. While Web search engine 20 is shown as a single network node, Web search engine 20 may be implemented as an intranet having any number of network nodes.

Proxy server 10 includes a search agent 12 and a network interface 14. Search agent 12 is a microprocessor-driven software application interfacing with search client 34 over access network 50 and with Web search server 22 over backbone network 40. Search agent 12 intelligently integrates search pairs including keywords and associated keyword priorities accepted on user interface 32 and received from search client 34 and represents search client 34 in a querying session with Web search server 22 to determine a conforming search response for return to search client 34 and display on user interface 32. Representation of search client 34 includes receipt by search agent 12 of a front-end query (e.g. first HTTP GET request) from search client 34 having search pairs and a target result parameter (e.g. in a URI); resolving a search string using the search pairs; forming a back-end query (e.g. second HTTP GET request) including the search string; and transmitting the back-end query to Web search server 22. Representation of search client 34 further includes receiving a back-end response from Web search server 22; updating a result list by appending any non-duplicative search results returned in the back-end response to the former result list (if any); comparing for conformity the updated result list with the target result parameter; and either (a) in the case of non-conformity, generating a new search string using the search pairs and repeating the back-end representation of search client 34 for the new search string, or (b) in the case of conformity, forming a front-end response using the result list and transmitting the front-end response to the search client 34. Where, for example, the target result parameter is a target result count, if the result count of the updated result list is less than the target result count, there is non-conformity and approach (a) (i.e. further querying) is followed. If the result count of the updated result list is equal to or greater than the target result count, there is conformity and approach (b) (i.e. no further querying) is followed. Network interface 14 is an application specific integrated circuit (ASIC)-based physical, data link and network layer device for transmitting, receiving and formatting information exchanged between proxy server 10 and other nodes.

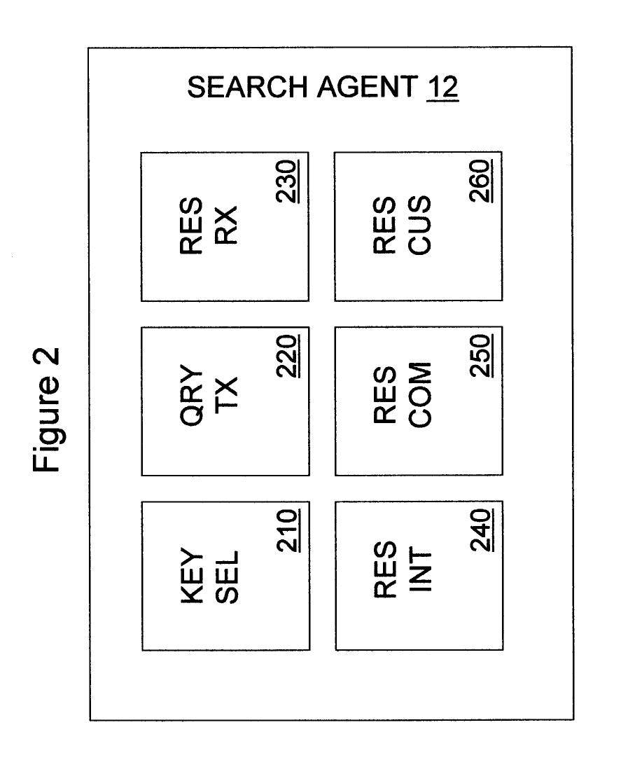

A functional diagram of search agent 12 is shown in FIG. 2. Agent 12 performs a keyword group selection (KEY SEL) function 210. KEY SEL 210 serves, in preparation for a back-end query, to select a group of keywords for the search string of the back-end query. For a first back-end query, the selected group of keywords includes all keywords received by search agent 12 from search client 34 in the front-end query. For a second or subsequent back-end query, KEY SEL 210 selects from among all groups of keywords not previously selected the group with the highest composite priority.

Keyword group composite priorities may be determined in several ways. In a first example, keyword priorities are treated as keyword weights for direct application. For each group of keywords not previously selected, KEY SEL 210 sums the priorities of the keywords in the group to calculate the group's composite priority. The composite priorities of all groups so calculated are compared with one another and the group having the highest composite priority is selected. If there is a tie among two or more groups, all of the two or more groups are selected. If, for example, there are four keywords A, B, C and D having keyword priorities 4, 3, 2 and 1, respectively, group ABCD is selected for the first search string followed in succession, until conformity with the target result parameter is achieved, by group ABC (composite priority “CP”=9), group ABD (CP=8), groups ACD and AB (CP=7), groups AC and BCD (CP=6), groups AD and BC (CP=5), groups A and BD (CP=4), groups B and CD (CP=3), group C (CP=2) and finally group D (CW=1).

In a second example, keyword priorities are treated as keyword rankings for resolution to keyword weights prior to application. A predetermined keyword priority-weight mapping may be used. If, for example, there are four keywords A, B, C and D having keyword priorities 1, 2, 3 and 4, and there is an effective priority-weight mapping wherein priority 1=weight 8, priority 2=weight 4, priority 3=weight 2 and priority 4=weight 1, group ABCD is selected for the first search string followed in succession, until conformity with the target result parameter is achieved, by group ABC (composite priority “CP”=14), group ABD (CP=13), group AB (CP=12), group ACD (CP=11), group AC (CP=10), group AD (CP=9), group A (CP=8), group BCD (CP=7), group BC (CP=6), group BD (CP=5), group B (CP=4), group CD (CP=3), group C (CP=2) and finally group D (CP=1).

Agent 12 also performs a query transmit (QRY TX) function 220. QRY TX 220 serves, after selection the keyword group for the current search string, to form a current back-end query including the current search string and transmit the current back-end query to Web search server 22. QRY TX 220 includes resolving the search string to a URI using query syntax specified for Web search server 22, encapsulating the URIs in an HTTP GET request and transmitting the HTTP GET request to Web search server 22. If two or more keyword groups were selected in the current round due to a tie, QRY TX 220 forms two or more corresponding current back-end queries, one per selected keyword group, and transmits the two or more current back-end queries successively to Web search server 22.

Agent 12 also performs a response receive (RES RX) function 230. RES RX 230 serves, after transmitting a current back-end query to Web search server 22, to receive a current back-end response from Web search server 22. If two or more current back-end responses are received (as a result of two more keyword groups having been selected due to a current-round tie), RES RX 230 combines the two or more current back-end responses into a single current back-end response for further processing. Combining two or more current back-end responses includes integrating the search results returned in the two or more current back-end responses in accordance with relevancy scores provided by Web search server 22 and eliminating any duplicate search results.

Agent 12 also performs a result integrate (RES INT) function 240. RES INT 240 serves, after receiving a current back-end response from Web search server 22, for updating the result list. RES INT 240 compares the search results returned in the current back-end response with search results in the result list, filters any duplicative search results and appends any non-duplicative search results to the result list. Of course, for the first back-end response of a querying session, there is no need to filter duplicative search results and the search results from the current back-end response are the initial entries in the result list. It will be appreciated that appending non-duplicative search results from the current back-end response to the list compiled from previous back-end responses leads to ordering of the search results in accordance with the search order. That is, any search results returned from the highest priority search appear in the result list before any search results returned from the second highest priority search, which appear before any search results returned from the third highest priority search, and so on. Because the search order is user-prioritized in accordance with the user-provided keyword priorities, the search results are advantageously user-prioritized as well.

Of course, it is possible to deviate from strict ordering of the search results in accordance with the search order and still produce user-prioritized search results. For example, RES INT 240 may be arranged to integrate search results into the result list in accordance with composite relevancy scores determined as a function of both the composite keyword group priorities of the searches which produce the results and relevancy scores determined by Web search engine 20 and returned with the results in back-end responses. In that event, search results would be ordered in consideration of both user-prioritized criteria and abstract criteria determined by Web search engine 20, such as the proximity of different keywords within the Web page or the popularity of the Web page.

Agent 12 also performs a result compare (RES COM) function 250. RES COM 250 serves, after updating the result list, to compare the result count of the result list with a target result parameter received by search agent 12 from search client 34 in the front-end query. Where the target result parameter is a target result count, for example, RES COM 240 determines the result count for the result list and compares the result list result count and the target result count. If the result list result count is less than the target result count, RES COM 250 prompts KEY SEL 210 to proceed with further keyword group selection for further querying. If the result list result count is greater than or equal to the target result count, RES COM 250 prompts result customization (RES CUS) function 260 to proceed with front-end response generation.

Agent 12 also performs a result customization (RES CUS) function 260. RES CUS 260 serves, after receipt of a prompt from RES COM 240, to generate a front-end response in a standard HTML or XML display format for facilitating display of the search results in the result list by search client 34 and transmit the front-end response to search client 34.

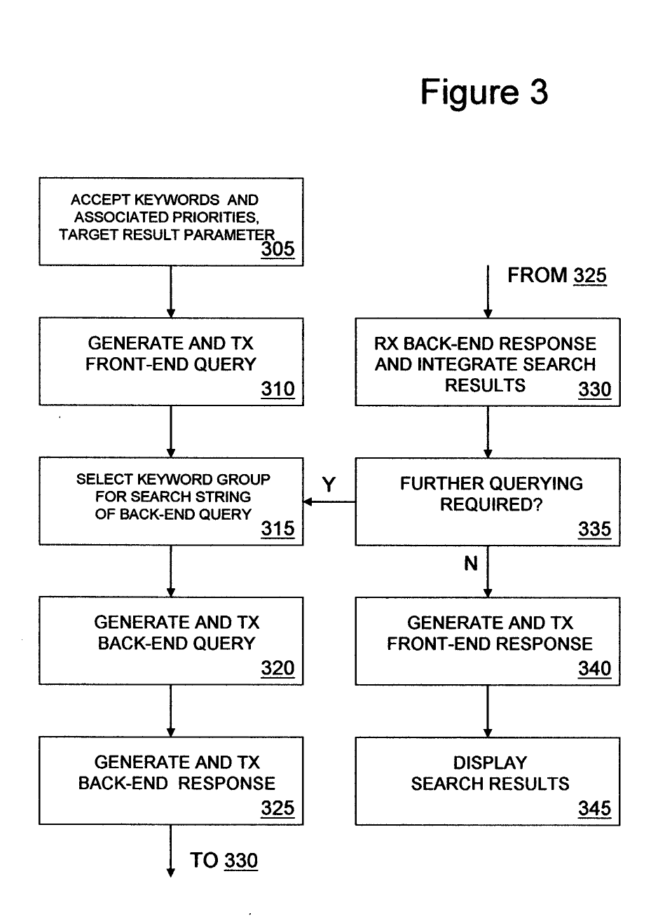

Turning to FIG. 3, a flow diagram illustrates a preferred method for implementing the first preferred embodiment. On end-user system 30, search client 34 accepts search pairs including keywords and associated keyword priorities, and also a target result parameter (305). Search pairs and target result parameter may be “keyed in” on user interface 32 or may be implicit in mouse click selections made on user interface 32. Search client 34 generates a front-end query including the search pairs and target result parameter and transmits the front-end query to proxy server 10 (310). On proxy server 10, search agent 34 performs a keyword group selection (KEY SEL) function 210 to select a keyword group for a search string of a back-end query (315). Search agent 34 performs a query transmit (QRY TX) function 220 which forms a back-end query with the search string and transmits the back-end query to Web search engine 20 (320). On Web search engine 20, Web search server 22 resolves the back-end query to a back-end response including search results relevant to the back-end query and transmits the back-end response to proxy server 10 (325). On proxy server 10, search agent 34 performs a response receive (RES RX) function 230 followed by a result integrate (RES INT) function 240 (330) in which the search results from the back-end response are integrated with any search results from prior back-end responses in this querying session in a result list. Search agent 34 then performs a result compare (RES COM) function 250 comparing the result list and the target result parameter to determine whether further querying is indicated (335). If further querying is indicated, the process returns to Step 315. If further querying is not indicated, search agent 34 performs a result customization (RES CUS) function 260 to generate a front-end response for facilitating display of the search results by search client 34 and transmits the front-end response to end-user station 30 (340). On end-user station 30, search client 34 facilitates display of the search results on user interface 32 (345).

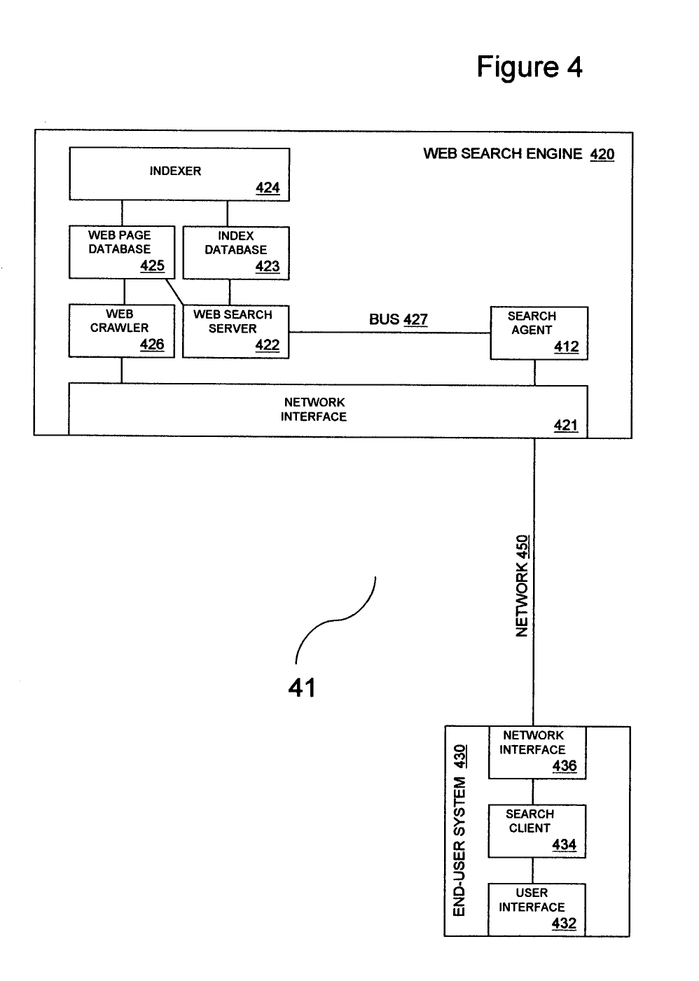

Turning finally to FIG. 4, in a second preferred embodiment, a network architecture 41 includes a Web search engine 420 and an end-user system 430 interconnected via a network 450. In the second preferred embodiment, search agent 412 and Web search server 422 are co-located at Web search engine 420 and communicate over a bus 427.

Web search engine 420 includes a network interface 421, index database 423, an indexer 424, a Web page database 425 and a Web crawler 426 operatively identical to their counterparts in the first preferred embodiment.

Web search engine 420 includes a Web search server 422 and search agent 412 operatively identical to their counterparts Web search server 22 and search agent 12 in the first preferred embodiment, except Web search server 422 and search agent 412 are co-located on Web search engine 420 and exchange back-end queries and back-end responses over bus 427. Bus 427 is a data line interconnecting Web search server 422 and search agent 412 using a standard local area network (LAN) communication protocol such as Ethernet, Token Ring, Fiber Distributed Data Interface (FDDI) or, alternatively, a proprietary bus protocol.

End-user system 430 includes a user interface 432, a search client 434 and a network interface 436 operatively identical to their counterparts user interface 32, search client 34 and network interface 36 in the first preferred embodiment, except end-user system 430 exchanges front-end queries and front-end responses with Web search engine 420.

It will be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

What is claimed is:

1. A method for prioritized searching, comprising:
accepting pairs of keywords and keyword priorities;
applying the pairs to produce prioritized search queries; and
applying the prioritized search queries to produce prioritized search results.

2. The method of claim 1, further comprising the step of:
displaying the prioritized search results.

3. A method for prioritized searching, comprising:
accepting pairs of keywords and keyword priorities;
applying the pairs to produce prioritized search queries;
applying the prioritized search queries to produce prioritized search results; and
checking for conformity between the prioritized search results and a target result parameter.

4. The method of claim 3, further comprising the step of:
inhibiting the display of any of the prioritized search results prior to confirming conformity between the prioritized search results and the target result parameter.

5. The method of claim 3, further comprising the step of:
displaying the prioritized search results upon confirming conformity between the prioritized search results and the target result parameter.

6. The method of claim 3, further comprising the step of:
accepting the target result parameter.

7. The method of claim 3, wherein the target result parameter is a target search result count.

8. A prioritized search system, comprising:
a search client;
a search agent; and
a search server,
wherein the search client transmits pairs of keywords and keyword priorities to the search agent, and the search agent applies the pairs to produce prioritized search queries and applies the prioritized search queries to the search server to produce prioritized search results.

9. The system of claim 8, wherein the search client is a Web browser.

10. The system of claim 8, wherein the search server is a Web search engine query server.

11. The system of claim 8, wherein the search client, the search agent and the search server reside on a first, second and third network node, respectively.

12. The system of claim 8, wherein the search client resides on a first network node and the search agent and search server reside on a second network node.

13. A prioritized search system, comprising:
a search client;
a search agent; and
a search server,
wherein the search client transmits pairs of keywords and keyword priorities to the search agent, and the search agent: applies the pairs to produce prioritized search queries, applies the prioritized search queries to the search server to produce prioritized search results and checks for conformity between the prioritized search results and a target result parameter.

14. The system of claim 13, wherein the search agent inhibits the return of any of the prioritized search results to the search client prior to confirming conformity with the target result parameter.

15. The system of claim 13, wherein the search agent returns the prioritized search results to the search client upon confirming conformity with the target result parameter.

16. The system of claim 13, wherein the search client is a Web browser.

17. The system of claim 13, wherein the search server is a Web search engine query server.

18. The system of claim 13, wherein the search client, the search agent and the search server reside on a first, second and third network node, respectively.

19. The system of claim 13, wherein the search client resides on a first network node and the search agent and search server reside on a second network node.

20. The system of claim 13, wherein the target result parameter is a target search result count.

21. A method for user-prioritized searching, comprising:
accepting pairs of keywords and keyword priorities from a user;
applying the pairs to produce user-prioritized search queries; and
applying the user-prioritized search queries to produce user-prioritized search results.

22. The method of claim 21, further comprising the step of:
returning the user-prioritized search results to the user.

23. A method for user-prioritized searching, comprising:
accepting pairs of keywords and keyword priorities from a user;
applying the pairs to produce user-prioritized search queries;
applying the user-prioritized search queries to produce user-prioritized search results; and
checking for conformity between the user-prioritized search results and a target result parameter.

24. The method of claim 23, further comprising the step of:
inhibiting the return of any of the user-prioritized search results to the user prior to confirming conformity between the user-prioritized search results and the target result parameter.

25. The method of claim 23, further comprising the step of:
returning the user-prioritized search results to the user upon confirming conformity between the user-prioritized search results and the target result parameter.

26. The method of claim 23, further comprising the step of:
accepting the target result parameter from the user.

27. The method of claim 23, wherein the target result parameter is a target search result count.

28. A method for user-prioritized searching, comprising:
accepting pairs of keywords and keyword priorities on a user interface;
applying the pairs to produce user-prioritized search queries; and
applying the user-prioritized search queries to produce user-prioritized search results.

29. The method of claim 28, further comprising the step of:
displaying the user-prioritized search results on the user interface.

30. A search agent for a prioritized search system, comprising:
a receiver for receiving pairs of keywords and keyword priorities;
a selector for producing prioritized search queries from the pairs; and
a transmitter for transmitting the prioritized search queries.
